(19) United States
(12) Patent Application Publication
(10) Pub. No.: US 2016/0224142 A1
(43) Pub. Date: Aug. 4, 2016

(54) TOUCH DEVICE

(71) Applicant: TPK Touch Solutions (Xiamen) Inc., Xiamen (CN)

(72) Inventors: Hebo Yang, Xiamen (CN); Yuh-Wen Lee, Hsinchu (TW); Yu Zhang, Xiamen (CN); Fu-Yu Su, New Taipei (TW); Liangzhen Xu, Xiamen (CN); Chao Gao, Xiamen (CN); Fengming Fengming, Fuzhou (CN); Shidu Liao, Fujian (CN)

(21) Appl. No.: 15/012,876

(22) Filed: Feb. 2, 2016

(30) Foreign Application Priority Data
Feb. 3, 2015 (CN) 201510055936.9
Apr. 24, 2015 (CN) 201510198175.2

(51) Int. Cl. G06F 3/041

(52) U.S. Cl. CPC G06F 3/041

(57) ABSTRACT

A touch device comprises a touch sensing structure, a cover lens, a first mask layer, a second mask layer and a fingerprint identification structure. The cover lens has a first surface and a second surface opposite to the first surface. The cover lens has a groove; the groove is disposed on the second surface and has a top surface and side surfaces adjacent to the top surface. The first mask layer covers the top surface of the groove. The second mask surface covers the side surface of the groove. The color of the first mask layer and the second mask layer are different. At least a portion of the fingerprint identification structure is disposed on the top surface in the groove. The touch sensing structure is disposed on the second surface.

### CROSS REFERENCE TO RELATED APPLICATIONS

This Non-provisional application claims priority under 35 U.S.C. §119(a) to Chinese Patent Application No. 201510055936.9 filed in the People's Republic of China on Feb. 3, 2015 and Chinese Patent Application No. 201510198175.2 filed in the People's Republic of China on Apr. 24, 2015, the entire contents of which are hereby incorporated by reference.

### BACKGROUND OF THE DISCLOSURE

1. Field of the Disclosure

The present disclosure relates to touch technology field, and more particularly, to a touch device.

2. Description of the Related Art

As technology progresses, fingerprint identification technology is widely applied to various electronic devices because of the security identification features it provides. In recent years, fingerprint identification technology has been used for mobile devices due to its good security and privacy protection. Accordingly, the fingerprint identification technology has become the focus of public attention, and will become a subsequent important development direction of similar electronic devices.

A touch device typically includes a cover lens, which is configured to provide an operation area for users giving control by touching and protects functional elements under the cover lens, and a fingerprint identified structure, which is disposed under the cover lens, especially in a groove of the lower surface of the cover lens. Considering the touch operation area side of the touch device, the existence of the groove may affect the visual appearance of the touch device. For instance, the light may leak from side surfaces of the groove, or appearance defects may occur due to the height difference of the side surface and the button surface of the groove.

### SUMMARY OF THE DISCLOSURE

In view of above mentioned, an embodiment of the disclosure provides a touch device. The touch device includes a touch sensing structure, a cover lens, a first mask layer, a second mask layer and a fingerprint identified structure. The cover lens has a first surface and a second surface opposite to the first surface. The first surface is a touch surface. The cover lens has a groove, which is disposed on the second surface, and has a top surface and a side surface adjacent to the top surface. The first mask layer covers the top surface of the groove. The second mask layer covers the side surface of the groove, which the color of the second mask layer and the first mask layer are different. At least a portion of the fingerprint identified structure is disposed on the top surface in the groove. The touch sensing structure is disposed on the second surface.

In some embodiments of the disclosure, the orthographic projection of the first mask layer on the first surface is a fingerprint identified area, the orthographic projection of the second mask layer on the first surface is a fingerprint labeled area, and the fingerprint identified area is surrounded by the fingerprint labeled area.

In some embodiments of the instant disclosure, the first mask layer further covers a peripheral area of the second surface to form a frame area, and the fingerprint identified area and the fingerprint labeled area are in the frame area.

In some embodiments of the instant disclosure, a color of the first mask layer and the second mask layer are black, white, red, gold or blue respectively.

In some embodiments of the instant disclosure, the second mask layer is formed on the side surface by pad printing or ink jet printing.

In some embodiments of the instant disclosure, an angle between the top surface and the side surface is greater than 90 degrees.

In some embodiments of the instant disclosure, the angle between the top surface and the side surface is in a range from 90 degrees to 175 degrees.

In some embodiments of the instant disclosure, the angle between the top surface and the side surface is in a range from 110 degrees to 165 degrees.

In some embodiments of the instant disclosure, a minimum distance between the top surface of the fingerprint identified structure and the first surface of the cover lens is in a range from 10 μm to 500 μm.

In some embodiments of the instant disclosure, a surface of the fingerprint identified structure close to the top surface of the groove is a top surface of the fingerprint identified structure, and the minimum distance between the top surface of the fingerprint identified structure and the first surface of the cover lens is in a range from 50 μm to 450 μm or from 80 μm to 400 μm.

In some embodiments of the instant disclosure, the touch device further includes a first fixed layer disposed between the fingerprint identified structure and the first mask layer.

In some embodiments of the instant disclosure, the touch device further includes a second fixed layer disposed between the fingerprint identified structure and the second mask layer.

In some embodiments of the instant disclosure, the first fixed layer and the second fixed layer fill the groove.

In some embodiments of the instant disclosure, the second fixed layer encompasses the fingerprint identified structure.

In some embodiments of the instant disclosure, the fingerprint identified structure is in direct contact with the first mask layer.

In some embodiments of the instant disclosure, the fingerprint identified structure is a sensing electrode structure disposed in the groove and on a portion of the second surface.

In some embodiments of the instant disclosure, the fingerprint identified structure is an integrated circuit chip.

In some embodiments of the instant disclosure, the touch sensing structure is a touch sensing electrode structure formed on the cover lens.

In some embodiments of the instant disclosure, the touch sensing structure includes a substrate and a touch sensing layer disposed on a side of the substrate, and the touch sensing layer is the touch sensing electrode structure.

In some embodiments of the instant disclosure, the cover lens further has a side surface connecting the first surface and the second surface, and the touch device further includes a buffer layer disposed on the side surface which connects the first surface and the second surface.

In some embodiments of the instant disclosure, the touch device further includes a first optical repair layer disposed between the top surface and the first mask layer.

In some embodiments of the instant disclosure, the touch device further includes a second optical repair layer disposed between the side surface and the second mask layer.

In some embodiments of the instant disclosure, a thickness of the first optical repair layer is in a range from 1 μm to 100 μm.

In some embodiments of the instant disclosure, a material of the first optical repair layer is a transparent organic gel, a transparent ink or a semi-transparent ink.

In some embodiments of the instant disclosure, a thickness and a material of the second optical repair layer and the first optical repair layer are the same.

The first mask layer and the second mask layer have different color and cover the top surface and the side surface of the groove respectively. The first mask layer and the second mask layer have more uniform shielding for opaque elements such as the fingerprint identified structure under the first mask layer and the second mask layer, so as to prevent the light leaking from the groove, especially from the side surface of the groove. The color difference between the first mask layer and the second mask layer are used to enhance their color contrast, so as to improve the poor visual appearance of the touch device caused by the same color mask layer, which cannot uniform shielding due to the different reflection angles of light on the side surface and top surface of the groove. The second mask layer may be formed as the fingerprint labeled area to specifically indicate the location of the fingerprint identified area.

A first optical repair layer is disposed between the top surface of the groove and the first mask layer, and a second optical repair layer is disposed between the side surface of the groove and the second mask layer. The first optical repair layer and the second optical repair layer fill and repair marks and tiny cracks of the groove due to the surface treatment process, reduce fogging and modified marks. Consequently, the surface of the groove becomes transparent and flat, the optical performance is recovered, and the appearance is improved.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic top view of a touch device according to some embodiment of the disclosure.

FIG. 2 is a cross-sectional view of a touch device taken along line 2 shown in FIG. 1 according to some embodiment of the disclosure.

FIG. 3 is a cross-sectional view of a touch device taken along line 2 shown in FIG. 1 according to some embodiment of the disclosure.

FIG. 4 is a cross-sectional view of a touch device taken along line 2 shown in FIG. 1 according to some embodiment of the disclosure.

FIG. 5 is a cross-sectional view of a touch device taken along line 2 shown in FIG. 1 according to some embodiment of the disclosure.

FIG. 6 is a cross-sectional view of a touch device taken along line 2 shown in FIG. 1 according to some embodiment of the disclosure.

FIG. 7 is a cross-sectional view of a touch device taken along line 2 shown in FIG. 1 according to some embodiment of the disclosure.

FIG. 8 is a cross-sectional view of a touch device taken along line 2 shown in FIG. 1 according to some embodiment of the disclosure.

FIG. 9 is a cross-sectional view of a touch device taken along line 2 shown in FIG. 1 according to some embodiment of the disclosure.

FIG. 10 is a cross-sectional view of a touch device taken along line 2 shown in FIG. 1 according to some embodiment of the disclosure.

FIG. 11 is a cross-sectional view of a touch device taken along line 2 shown in FIG. 1 according to some embodiment of the disclosure.

FIG. 12 is a cross-sectional view of a touch device taken along line 2 shown in FIG. 1 according to some embodiment of the disclosure.

FIG. 13 is a cross-sectional view of a touch device taken along line 2 shown in FIG. 1 according to some embodiment of the disclosure.

FIG. 14 is a cross-sectional view of a touch device taken along line 2 shown in FIG. 1 according to some embodiment of the disclosure.

### DETAILED DESCRIPTION OF THE DISCLOSURE

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present disclosure. Furthermore, for simplifying the drawings, some of the conventional structures and elements are shown with schematic illustrations.

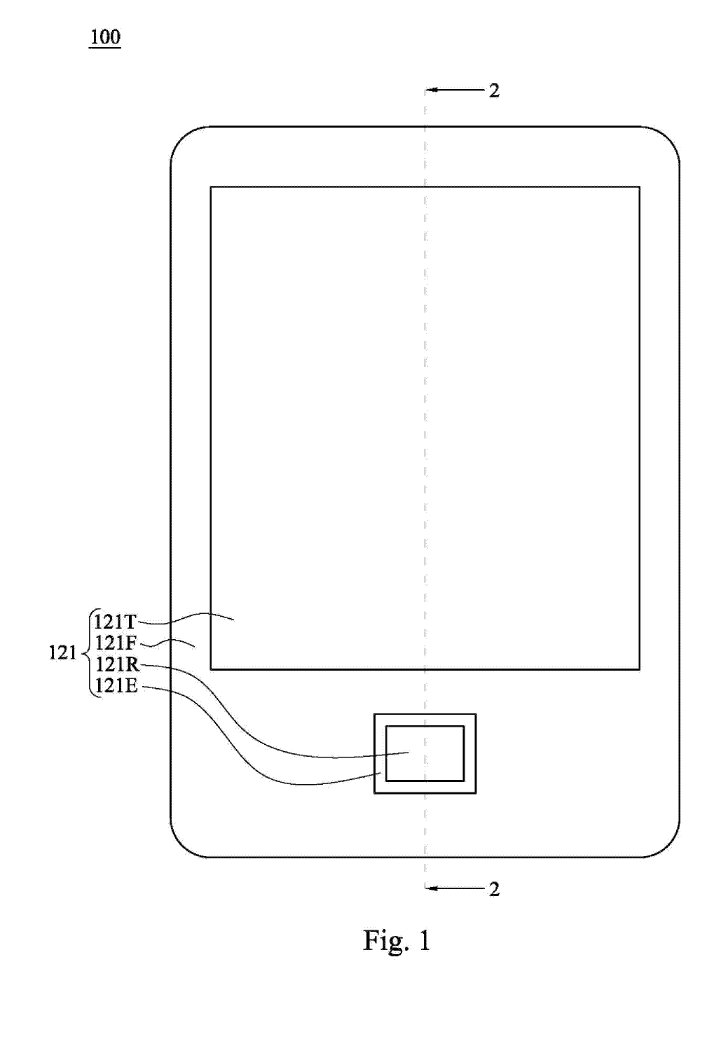

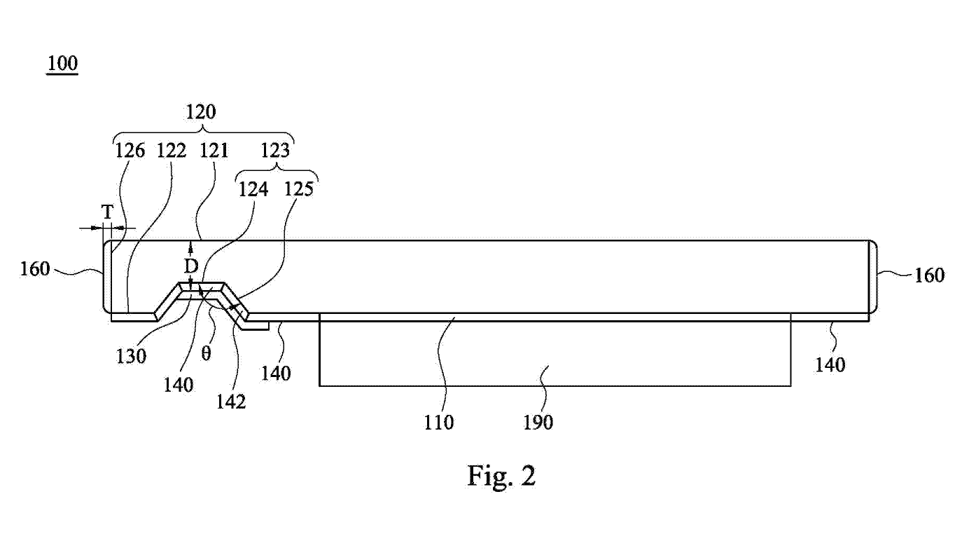

FIG. 1 is a schematic top view of a touch device 100 according to some embodiments of the disclosure. FIG. 2 is a cross-sectional view of the touch device 100 taken along line 2 shown in FIG. 1 according to some embodiments of the disclosure. The touch device 100 may be used in a mobile device such as a smart phone or a tablet computer.

As shown in FIGS. 1 and 2, the touch device 100 includes a touch sensing structure 110, a cover lens 120, a fingerprint identification structure 130, a first mask layer 140 and a second mask layer 142. The cover lens 120 has a first surface 121 and a second surface 122 opposite to the first surface 121. The first surface 121 is provided as a touch surface for users. The touch sensing structure 110 is disposed on and in direct physical contact with the second surface 122 in some embodiments. The cover lens 120 has a groove 123, which is cut into the second surface 122 and thus is disposed on the second surface 122. The groove 123 has a top surface 124 and a side surface 125 adjacent to the top surface 124. An angle θ between the top surface 124 and side surface 125 is greater than 90 degrees. Specifically, the groove 123 is formed by depressed from the second surface 122 in toward the first surface 121. At least a portion of the fingerprint identification structure 130 is disposed on the top surface 124 in the groove 123. The first mask layer 140 covers the top surface 124 of the groove 123, the second mask layer 142 covers the side surface 125 of the groove 123, and a color of the first mask layer 140 and the second mask layer 142 are different.

More specifically, the color of the first mask layer 140 and the second mask layer 142 is black, white, red, gold or blue respectively.

In addition, the orthographic projection of the first mask layer 140 on the first surface 121 is a fingerprint identification area 121R, the orthographic projection of the second mask layer 142 on the first surface 121 is a fingerprint labeled area 121E. The fingerprint identification area 121R is surrounded by the fingerprint labeled area 121E. Specifically, the fingerprint labeled area 121E is located on at least one side of the fingerprint identification area 121R so as to specifically indicate the location of the fingerprint identification area 121R. Further, the first mask layer 140 further covers a peripheral area of the second surface 122 to form a frame area 121F, and an area, which is not covered by the first mask layer 140 and the second mask layer 142, is defined as touch display area 121T. The frame area 121F is located on at least one side of the touch display area 121T. The fingerprint identification area 121R and the fingerprint labeled area 121E are located in the frame area 121F.

Accordingly, the first surface 121 in a top view is divided into the touch display area 121T, the frame area 121F, fingerprint identification area 121R, and the fingerprint labeled area 121E, as shown in FIG. 1. Specifically, the orthographic projection of the frame area 121F on the second surface 122 is a portion of the second surface 122 covered by the first mask layer 140. The orthographic projection of the touch display area 121T on the second surface 122 is a portion of the second surface 122 corresponding to the touch sensing structure 110, as shown in FIGS. 1 and 2. At least a portion of the orthographic projection of the fingerprint identification structure 130 on the first surface 121 overlaps with the fingerprint identification area 121R. In addition, the orthographic projection of the fingerprint identification structure 130 on the first surface 121 does not overlap with the orthographic projection of the touch sensing structure 110 on the first surface 121.

The side surface 125 of the groove 123 is covered by the first mask layer 140 and the second mask layer 142, which have different color, so as to form a fingerprint labeled area 121E, which can specifically indicate the location of the fingerprint identification area 121R for subsequent identifying fingerprint easily. Besides, using the same color mask layer or the first mask layer 140 simultaneously covering the side surface 125 and the top surface 124 of the groove 123 may cause the poor visual appearance of the touch device 100 due to the different reflection angles of light on the side surface 125 and top surface 124 of the groove 123, and the design of instant disclosure can prevent such problems of the poor visual appearance of the touch device 100.

Specifically, the first mask layer 140 is substituted with the second mask layer 142, so that the first mask layer 140 covers the side surface 125 and the top surface 124 of the groove 123. As a result, the frame area 121F and the fingerprint labeled area 121E are referred to together as a frame area because the first mask layer 140 covering the side surface 125 of the groove 123 and the first mask layer 140 covering the frame area 121F are the same color. However, the side surface 125 of the groove 123 is a slope connecting the top surface 124 and the second surface 122, and the first mask layer 140 corresponding to the fingerprint labeled area 121E is disposed on the slope. Therefore, when users look from the top side of the touch device 100, it will find that the color of the frame area 121F and fingerprint labeled area 121E have gradient difference so as to affect the visual appearance of the touch device 100.

In contrast, the first mask layer 140 and the second mask layer 142, which have different color, cover the top side 124 and the side surface 125 of the groove 123 respectively. As a result, the first mask layer 140 and the second mask layer 142 have more uniform shielding for opaque elements such as the fingerprint identification structure 130 on the top surface 124 and the side surface 125 of the groove 123 under the first mask layer 140 and the second mask layer 142. At the same time, the first mask layer 140 and the second mask layer 142 prevent the light leaking from the groove 123, especially from the side surface 125 of the groove 123. Since the colors of the first mask layer 140 and the second mask layer 142 are different, the color difference between the first mask layer 140 and the second mask layer 142 is fully used to enhance their color contrast, so as to improve the poor visual appearance of the touch device 100 caused by the same color mask layer, which cannot provide uniform shielding due to the different reflection angles of light on the side surface 125 and top surface 124 of the groove 123. In addition, the color of the second mask layer 142 and the first mask layer 140 are different, so that the second mask layer 142 is formed as the fingerprint labeled area 121E to specifically indicate the location of the fingerprint identification area 121R, and further enhance the convenience of use of the touch device.

In some embodiments of the instant disclosure, the shape of the fingerprint identification area 121R is a rectangle. The shape of a peripheral area of the fingerprint labeled area 121E, which is corresponding to the shape of the fingerprint identification area 121R, may include, but not limited to, a rectangle. In other embodiments, the shape of the fingerprint identification area 121R may be a diamond, a circle or an oval. The shape of a peripheral area of the fingerprint labeled area 121E, which is corresponding to the shape of the fingerprint identification area 121R, may be a diamond, a circle or an oval. Therefore, the exterior design of the touch device 100 is able to be stylized in various ways.

The first mask layer 140 and the second mask layer 142 are usually formed of opaque inks, photoresists or other similar materials to shield some opaque elements such as flexible circuit boards, conductive traces and other things under the cover lens 120. The first mask layer 140 may be a single-layer structure or a multi-layer structure stacked by the multi-layer material. A thickness of the first mask layer 140 is in a range from 0 to 20 μm. One should note that the materials of the first mask layer 140 and the second mask layer 142 mentioned above are only exemplary, but not intended to limit the instant disclosure. One of ordinary skill in the art of the instant disclosure should be flexible to choose the materials of the first mask layer 140 and the second mask layer 142 depending on the actual needs.

In some embodiments of the instant disclosure, a method of forming the first mask layer 140 on the top surface 124 of the cover lens 120 and the frame area 121F of the second surface 122 may be coating and then photolithography or silk-screen printing.

Specifically, a method of coating includes the following steps. First, the first mask layer 140 is coated on the top surface 124 of the groove 123 and the second surface 122. (The cover lens 120 compared to FIG. 2 is inverted at this time. In other words, the second surface 122 is an upper surface, and the groove 123 is upward.) Next, a process of photolithography is performed, and the first mask layer 140 covering the orthographic projection of the touch display area 121T on the second surface 122 is removed. As a result, the first mask layer 140 is uniformly formed on the top surface 124 of the cover lens 120 and an area located on the frame area 121F of the second surface 122.

The second mask layer 142 is formed on the side surface 125 of the cover lens 120 after that the first mask layer 140 is formed on the top surface 124 of the cover lens 120 and the area located on the frame area 121F of the second surface 122. A method of forming the second mask layer 142 on the side surface 125 of the cover lens 120 may be ink jet printing or pad printing.

A slope (as side surface 125) connecting the top surface 124 and the second surface 122 is formed because an angle between the top surface 124 and the side surface 125 is greater than 90 degrees. The second mask layer 142 may be directly formed on the side surface 125 by ink jet printing or pad printing. Therefore, the situation in which the second mask layer 142 cannot be formed on the side surface 125 or the second mask layer 142 cannot be uniformly formed on the side surface 125, which results in incomplete shielding of the first mask layer 140 and the second mask layer 142, does not occur.

In addition, it is noted that the first mask layer 140 and the second mask layer 142 are disposed between the cover lens 120 and the fingerprint identification structure 130. In other words, the first mask layer 140 and the second mask layer 142 are formed on the cover lens 120, and then the fingerprint identification structure 130 is formed on the first mask layer 140 and the second mask layer 142 during the process. Specifically, the fingerprinting identified structure 130 is at least disposed on the top surface 124 of the groove 123. Particularly, the fingerprinting identified structure 130 is disposed on the first mask layer 140 or further covers the second mask layer 142. The fingerprint identification structure 130 further covers the first mask layer 140 of the second surface 122 and is disposed on the second mask layer 142 covering the side surface 125 of the groove 123.

To ensure sensitivity and accuracy of fingerprint identification, the distance between the fingerprint identification structure 130 and the first surface 121 is reduced, so that the distance between the fingerprint identification structure 130 and the touch objects, such as fingers, is not too large. Simultaneously, in order to ensure the strength and impact resistance of the cover lens 120, and protect the elements such as the touch sensing structure 100 under the cover lens 120 from external destructive events, it is better to increase a thickness of the cover lens 120. Therefore, with forming the groove 123 on the second surface 122 of the cover lens 120 and disposing the fingerprint identification structure 130 in the groove 123, a portion of the cover lens 120 apart from the groove 123 still can maintain a proper thickness (in other words, the thickness D2 of the non-groove region is greater than the thickness D1 of the groove region), so as to ensure the sensitivity and accuracy of fingerprint identification, and the strength of the touch device 100 (or the strength of the cover lens 120).

Specifically, a minimum distance D between the first surface 121 and the top surface of the fingerprint identification structure 130 of the cover lens 120 may be in a range from 50 μm to 450 μm, so that the fingerprint identification structure 130 can be more sensitive to detect the fingerprint on the cover lens 120 during operation. In some embodiments, the minimum distance D may be in a range from 80 μm to 400 μm. The top surface of the fingerprint identification structure 130 is a surface of the fingerprint identification structure 130 near the top surface 124 of the groove 123. It should be noted that some functional films may be disposed on the first surface of the cover lens 120. In some embodiments, the functional layer is an antireflective, antiglare or other similar films. When other functional films are disposed on the first surface 121, the minimum distance D may be a minimum distance between a physical touch surface and the top surface of the fingerprint identification structure 130. In other words, it is a minimum distance between the top surface of the fingerprint identification structure 130 and a top surface, which is away from the cover lens 120, of the functional film.

The side surface 125 of the groove 123 will be formed as a slope connecting the top surface 124 and the second surface 122 because the angle between the top surface 124 and the side surface 125 is greater than 90 degrees. When the cover lens 120 is made of a high hardness material such as glass or the like, the groove having the slope is more easily formed on the second layer 122 compared to the groove of which the shape is a cube during the cover lens processing. Therefore, the production yield of the cover lens is effectively enhanced. In some embodiments of the instant disclosure, the angle between the top surface 124 and the side surface 125 may be in a range from 95 degrees to 175 degrees or 100 degrees to 165 degrees. It should be noted that the top surface 124 and the side surface 125 mentioned above are only exemplary, and not intended to limit the instant disclosure. Readers of the instant disclosure should be flexible to choose the combination of specific angle or shape of the top surface 124 and the side surface 125 depending on the actual needs.

In some embodiments, the side surface 125 is a planar surface. In other embodiments, the side surface 125 may be a curved surface bent inwardly or outwardly. In other embodiments, the side surface 125 may be a concave curved surface or a convex curved surface. When the side surface 125 is a curved surface, the angle between the top surface 124 and the side surface 125 is defined to be an angle between the top surface and a line connecting one end of the side surface 125 connected to the top surface and one end of the side surface 125 connected to the second surface 122.

In some embodiments, the fingerprint identification structure 130 is a capacitive fingerprint identification structure 130. More specifically, the fingerprint identification structure 130 is a sensing electrode structure disposed in the groove 123 and a portion of the second surface 122. More specifically, the fingerprint identification structure 130 is disposed on the top surface 124, the side surface 125 and the portion of the second surface 122 connected to the side surface 125. The fingerprint identification structure 130 disposed on the top surface 124 of the groove 123 is used for identifying the fingerprint of users. The fingerprint identification structure 130 disposed on the portion of the second surface 122 is used for connecting external lines. The fingerprint identification structure 130 disposed on the side surface 125 of the groove 123 is used for electrically connecting the fingerprint identification structure 130 disposed on the top surface 124 of the groove 123 and the fingerprint identification structure 130 disposed on the portion of the second surface 122.

For instance, a method of forming the fingerprint identification structure 130 may include the following steps. First, a conductive layer is deposited on the top surface 124 and side surface 125 of the groove 123 and the portion of the second surface 122 connected to the side surface 125. (The cover lens 120 compared to FIG. 2 is inverted at this time. In other words, the second surface 122 is an upper surface, and the groove 123 is upward.) Next, the fingerprint identification structure 130 is formed by patterning the conductive layer.

Since the side surface 125 of the groove 123 is formed as a slope connecting the top surface 124 and the second surface 122, the conductive layer is more easily formed on the side surface 125 of the groove 123 and the patterning process is easily performed. In addition, the fingerprint identification structure 130 is less prone to breakage and damage at the connection between the side surface 125 and the top surface 124, and the side surface 125 and the second surface 122 because the side surface 125 of the groove 123 between the top surface 124 and the second surface 122 has a gentler slope.

In some embodiments, a touch device 100 further includes a display module 190 disposed under the touch sensing structure. Consequently, the touch sensing structure 110 and the display module 190 cooperatively perform the touch and display functions. Display module 190 may be a liquid crystal display module (LCM), a light emitting diode (LED) display module, an organic light emitting diode (OLED) display module or other display modules which may be bonded to the touch sensing structure.

Specifically, the touch sensing structure 110 is a single-layer touch sensing electrode structure formed on the cover lens 120. In addition, the materials of the touch sensing structure 110 may be metal nano-wire, transparent metal oxide thin film, metal mesh or the like.

First, the touch sensing structure 110 is formed on the second surface 122. (The cover lens 120 compared to FIG. 2 is inverted at this time. In other words, the second surface 122 is an upper surface.) Subsequently, the cover lens 120 and the touch sensing structure 110 are disposed on the display module 190 during the process.

In some embodiments of instant disclosure, the cover lens 120 further has a side surface 126 connecting the first surface 121 and the second surface 122 (i.e., the first surface 121 and the second surface 122 are respectively the top surface and the bottom surface of the cover lens 120, and the side surface 126 is located between the first surface 121 and the second surface 122). The touch device 100 further comprises a buffer layer 160 disposed on the side surface 126. Specifically, the materials of the buffer layer 160 may be glue. More specifically, the glue may be a colloid which is flowing and sticky. The material of the glue is acrylic resin which is liquid at room temperature (e.g. 20-27° C.) and may be formed by curing such as ultraviolet curing. When the glue is liquid, the glue may be formed on the side surface 126 by injection molding, adhering, spraying, roller coating or the like. The viscosity of the glue may be in a range from 500 mPa·s to 1200 mPa·s, and the hardness of the glue after curing may be in a range from 70 D to 80 D (shore hardness). The maximum thickness T of the buffer layer 160 may be in a range from 0.03 μm to 0.2 μm, preferably from 0.08 μm to 0.12 μm. An outer surface of the buffer layer 160 is away from the side surface 126, so that the buffer layer 160 may protect the cover lens 120 by buffering the external force. Alternatively, the cover lens 120 may have micro-cracks or gaps on the side surface 126 after processing, and the buffer layer 160 under a liquid state can perform the capillary action with the micro-cracks or gaps of the side surface 126 and repair the micro-cracks or gaps to enhance the strength of the cover lens 120. Further, the glue having the features stated above is used for forming a buffer layer 160, so that the buffer layer 160 are tightly and firmly bonded to the side surface 126 to enhance the impact resistance and crack resistance of the side surface 126. As a result, a whole strength of the cover lens 120 and the touch device 100 are enhanced. Especially for the OGS(one glass solution), it may enhance the ability of the drop resistance and the impact resistance of the touch panel.

In some embodiments, the materials of the cover lens 120 are transparent and have high hardness. For instance, the materials of the cover lens 120 may be tempered glass, sapphire or polymethylmethacrylate (PMMA). The first surface 121 and the second surface 122 of the cover lens 120 are surfaces that undergo chemical or physical strengthening. Further, the side surface 126 of the cover lens 120 may also be a surface that undergoes chemical or physical strengthening. Therefore, the strength of the cover lens 120 is enhanced. The first surface 121 and the second surface 122 of the cover lens 120 may also be a curved surface, so that the cover lens 120 may be a three dimensional (3D) structure.

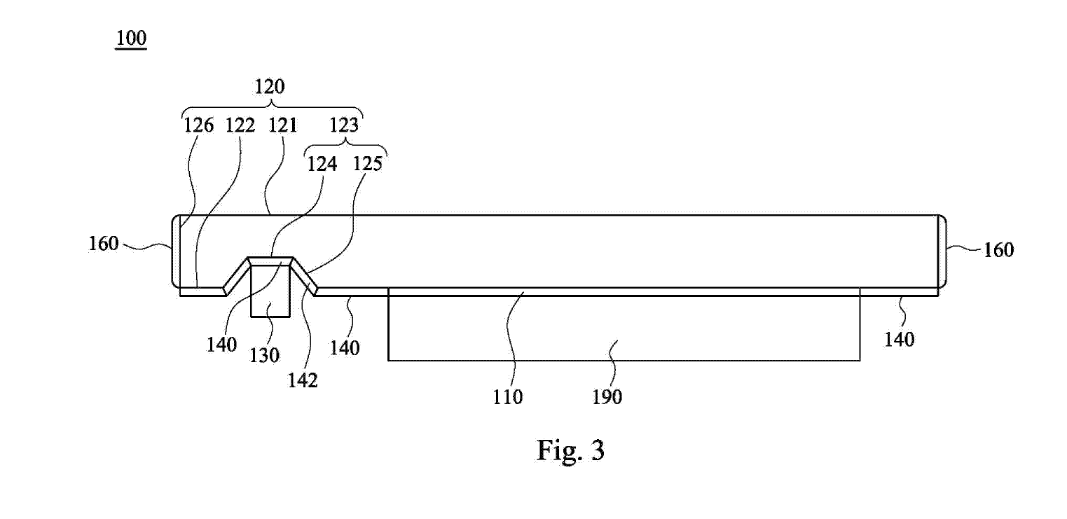

FIG. 3 is a cross-sectional view of a touch device 100 taken along line 2 shown in FIG. 1 according to some embodiments of the instant disclosure. The present embodiment is substantially the same as the foregoing embodiment, and the differences will be described hereafter.

A fingerprint identification structure 130 is an integrated circuit chip disposed under a top surface 124 of a groove 123 and in direct contact with a first mask layer 140 which covers the top surface 124 of the groove 123. It should be noted that the embodiments of the fingerprint identification structure 130 mentioned above are only exemplary, but not intended to limit the instant disclosure. One of ordinary skill in the art of the instant disclosure should be flexible to choose the embodiments of the fingerprint identification structure 130 depending on the actual needs.

In some embodiments, the first mask layer 140 is an opaque adhesive material, so that the first mask layer 140 has shielding function and may fix the fingerprint identification structure in the groove 123 of the cover lens 120.

In some embodiments, the fingerprint identification structure 130 does not have to be fixed in the groove 123 of the cover lens 120 by the first mask layer 140. Alternatively, the fingerprint identification structure 130 may also be fixed in the groove 123 of the cover lens 120 by disposing auxiliary components, or by designing the size or shape of the groove 123 to fix the fingerprint identification structure 130 in the groove 123 of the cover lens 120.

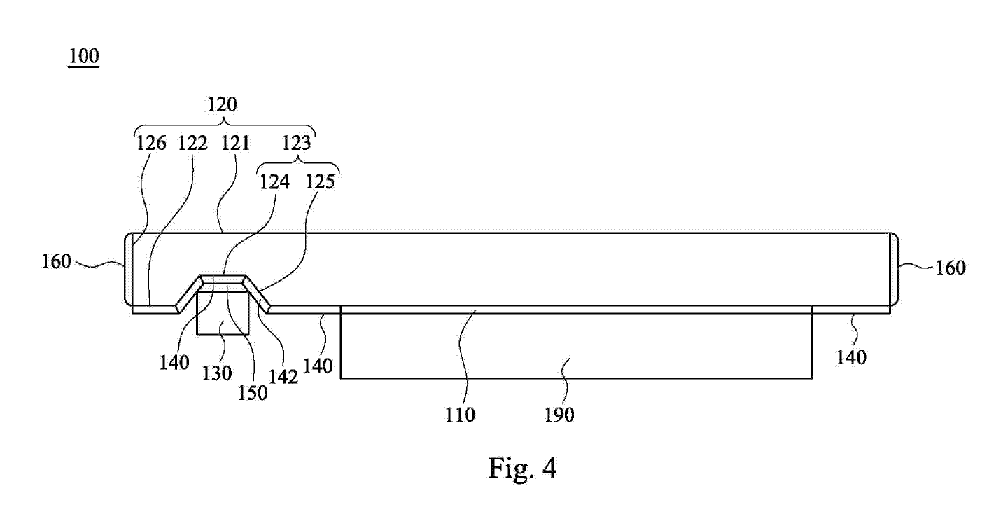

FIG. 4 is a cross-sectional view of a touch device 100 taken along line 2 shown in FIG. 1 according to some embodiments of the instant disclosure. The present embodiment is substantially the same as the embodiment of FIG. 3, and the major differences will be described hereafter.

In some embodiments, a first mask layer 140 only has shielding function. Accordingly, the touch device 100 further includes a first fixed layer 150 disposed between the fingerprint identification structure 130 and the first mask layer 140 to fix the fingerprint identification structure 130 in a groove 123 of a cover lens 120.

In some embodiments, the material of the first fixed layer 150 may be a sticky colloid such as optical cement and glue. More specifically, the major material of the glue is acrylic resin which is liquid at room temperature and may be formed by curing such as ultraviolet curing. When the glue is liquid, the glue may be formed between the fingerprint identification structure 130 and the first mask layer 140 by injection molding, adhering, spraying, roller coating or the likes, and tightly and firmly bonds the fingerprint identification structure 130 and the first mask layer 140 after curing. The viscosity of the glue may be in a range from 500 mPa·s to 1200 mPa·s, the hardness of the glue after curing may be in a range from 70 D to 80 D (shore hardness), and the thickness may be in a range from 5 μm to 50 μm. Therefore, the first fixed layer 150 may enhance the strength of the cover lens 120 in the groove 123, especially using the glue having the above features to form the first fixed layer 150 because of its viscosity and hardness which can further strengthen the strength of the cover lens 120 in the groove 123.

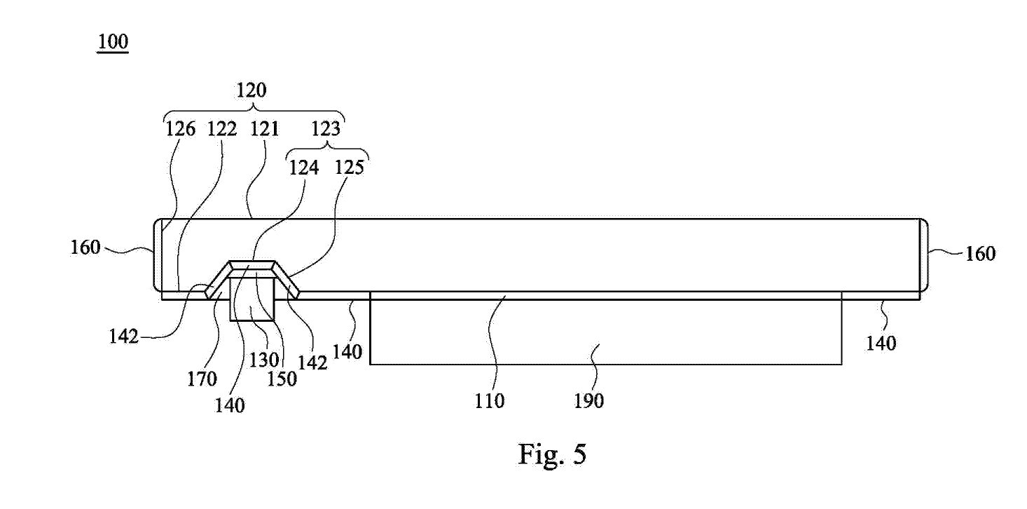

FIG. 5 is a cross-sectional view of a touch device 100 taken along line 2 shown in FIG. 1 according to some embodiments of the instant disclosure. The present embodiment is substantially the same as the embodiment of FIG. 4, and the major differences will be described hereafter.

As shown in FIG. 5, a touch device 100 further includes a second fixed layer 170. The second fixed layer 170 is disposed between a fingerprint identification structure 130 and a second mask layer 142, and fills a groove 123 to fix the fingerprint identification structure 130 in the groove 123 of a cover lens 120.

Specifically, the materials of a first fixed layer 150 may be a sticky colloid such as optical cement and glue. The major components and the forming method of the second fixed layer 170 are similar to the first fixed layer 150, and hence not repeated herein. The second fixed layer 170 and the first fixed layer 150 may be connected to each other and disposed between the fingerprint identification structure 130 and the first mask layer 140, and between the fingerprint identification structure 130 and the second mask layer 142.

The second fixed layer 170 can tightly and firmly bond the fingerprint identification structure 130 and the first mask layer 140 after curing, so that there is no gap between the groove 123 and the fingerprint identification structure 130. Therefore, the fixed layer 170 can firmly fix the fingerprint identification structure 130 in the groove 123 and further strengthen the strength of the cover lens 120 in the groove 123.

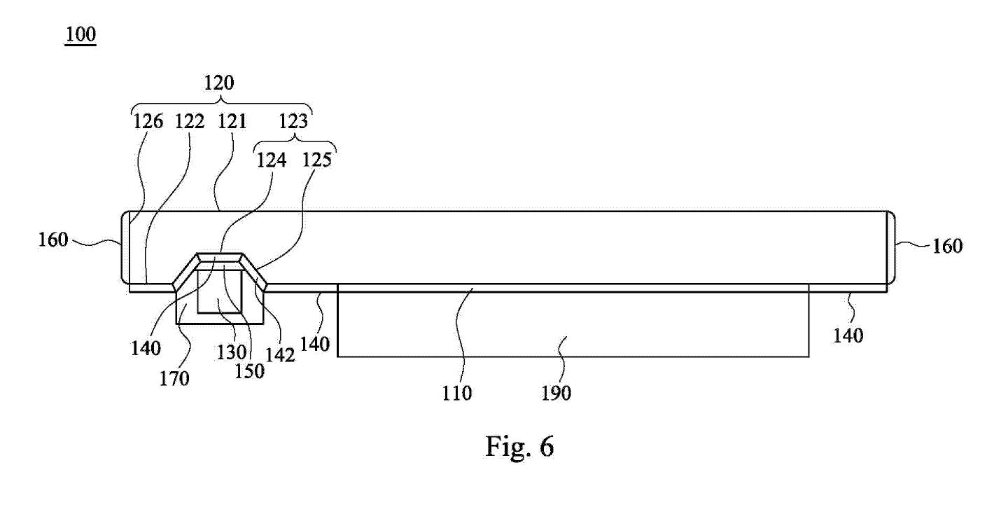

FIG. 6 is a cross-sectional view of a touch device 100 taken along line 2 shown in FIG. 1 according to further another embodiment of the instant disclosure. The touch device 100 of the present embodiment is substantially the same as the touch device 100 of FIG. 5, and the major differences will be described hereafter. In the present embodiment, the second fixed layer 170 is disposed between a fingerprint identification structure 130 and a second mask layer 142, and further covers the fingerprint identification structure 130. Therefore, the second fixed layer 170 can protect the fingerprint identification structure 130 by buffering the external force, and reduce the scratch or damage of the fingerprint identification structure 130 caused by the external force during the manufacturing process.

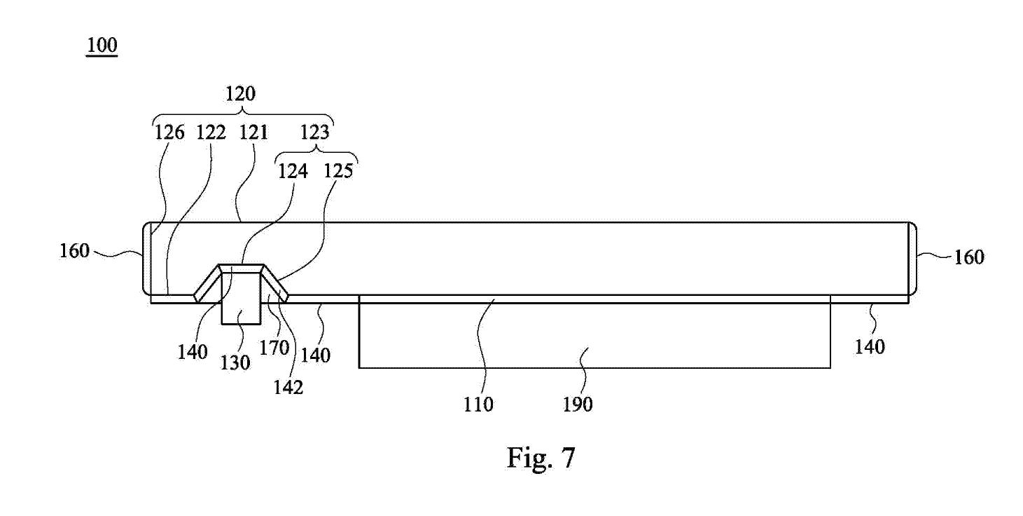

FIG. 7 is a cross-sectional view of a touch device 100 taken along line 2 shown in FIG. 1 according to yet another embodiment of the instant disclosure. The touch device 100 of the present embodiment is substantially the same as the touch device 100 of FIG. 5, and the major differences will be described hereafter. In the present embodiment, a fingerprint identification structure 130 of the touch device 100 is in direct contact with a first mask layer 140. In other words, there is no first fixed layer 150 between the fingerprint identification structure 130 and a top surface 124, and the fingerprint identification structure 130 is fixed in a groove 123 by a second fixed layer 170. In addition, the second fixed layer 170 may also be similar to the second fixed layer 170 in FIG. 6, and further cover the side surface and the button surface of the fingerprint identification structure 130.

The fingerprint identification structure 130 is in direct contact with and covers the first mask layer 140, so that a distance between the fingerprint identification structure 130 and the first surface 121 may be reduced in order to more improve sensitivity and accuracy of fingerprint identification.

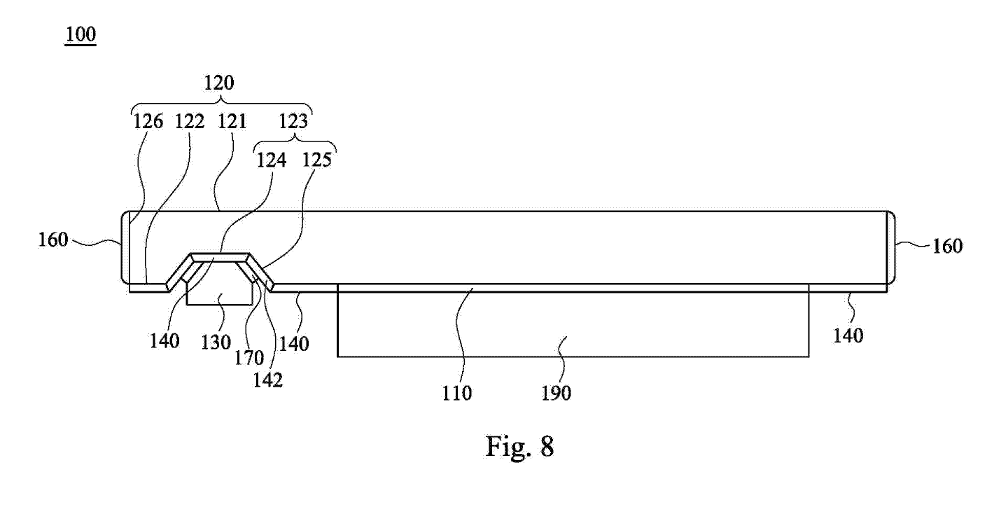

FIG. 8 is a cross-sectional view of a touch device 100 taken along line 2 shown in FIG. 1 according to yet another embodiment of the instant disclosure. The touch device 100 of the present embodiment is substantially the same as the touch device 100 of FIG. 3, and the major differences will be described hereafter. The first mask layer 140 only has shielding function, the touch device 100 further includes a second fixed layer 170, the fingerprint identification structure 130 is disposed on the side surface 125 by the second fixed layer 170, and the fingerprint identification structure 130 is in direct contact with the first mask layer 140. In other words, the second fixed layer 170 is disposed between the fingerprint identification structure 130 and the second mask layer 142, merely disposed on the second mask layer 142, (another portion of the second fixed layer is disposed on the first mask layer) and does not fill the groove 123.

Specifically, the materials of the second fixed layer 170 may be a sticky colloid such as optical cement or glue. The major components and the forming method of the second fixed layer 170 are similar to the first fixed layer 150, and hence not repeated herein.

The second fixed layer 170 can tightly and firmly bonds the fingerprint identification structure 130, the first mask layer 140 and the second mask layer 142 after curing, and hence the second fixed layer 170 can firmly fix the fingerprint identification structure 130 in the groove 123. In addition, the second fixed layer 170 has enough hardness and is disposed in the groove 123, and hence may strengthen the strength of the cover lens 120 in the groove 123.

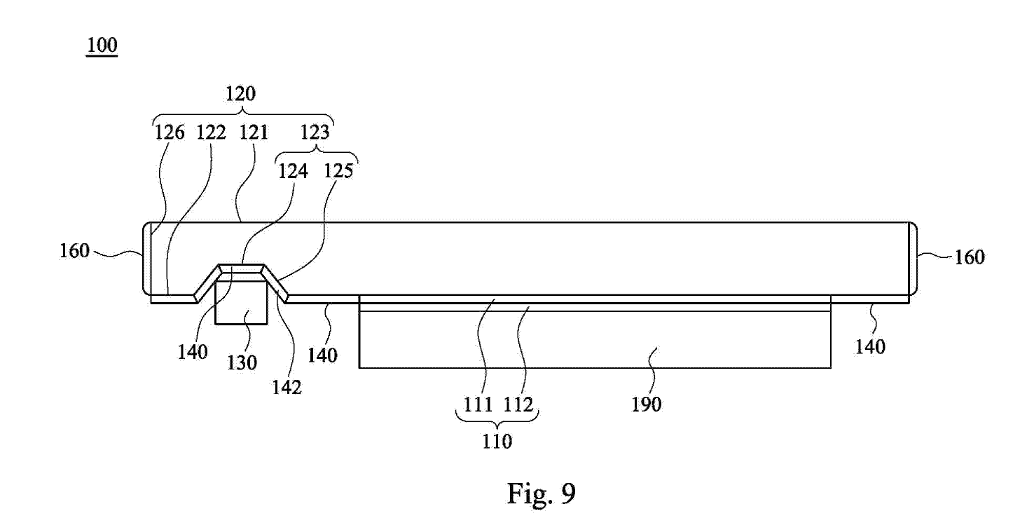

FIG. 9 is a cross-sectional view of a touch device 100 taken along line 2 shown in FIG. 1 according to further another embodiment of the instant disclosure. The touch device 100 of the present embodiment is substantially the same as the touch device 100 of FIG. 4, and the major differences will be described hereafter. In the present embodiment, the touch device 100 includes a substrate 111 and a touch sensing layer 112, the touch sensing layer 112 is disposed on a surface of the substrate 111, and the substrate 111 is disposed between the cover lens 120 and the touch sensing layer 112. In addition, the touch sensing structure 112 is a single-layer touch sensing electrode structure.

In a related manufacturing process, the touch sensing layer 112 is first formed on the substrate 111, the substrate 111 and the touch sensing layer 112 formed on the substrate 111 are subsequently bonded to a second surface 122 through the substrate 111 side and located on a touch display area 121T. Further, a display module 190 is bonded to the touch sensing layer 112.

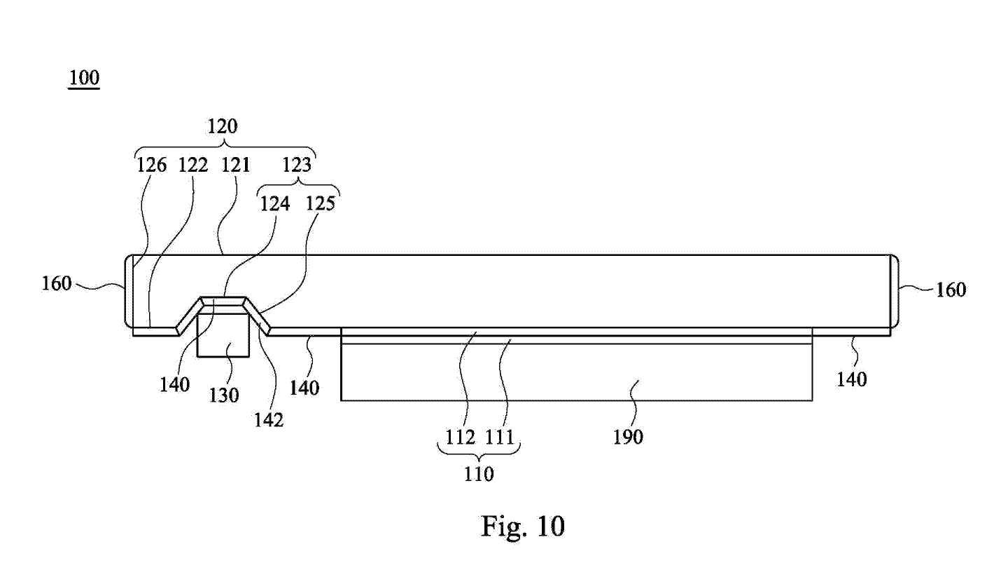

FIG. 10 is a cross-sectional view of a touch device 100 taken along line 2 shown in FIG. 1 according to yet another embodiment of the instant disclosure. The touch device 100 of the present embodiment is substantially the same as the touch device 100 of FIG. 9, and the major differences will be described hereafter. In the present embodiment, the touch sensing layer 112 is disposed on a substrate 111 and between a cover lens 120 and the substrate 111.

In a related manufacturing process, the touch sensing layer 112 is first formed on the substrate 111, the substrate 111 and the touch sensing layer 112 formed on the substrate 111 are subsequently bonded to a second surface 122 through the touch sensing layer 112 side, and a display module 190 is bonded to the substrate 111.

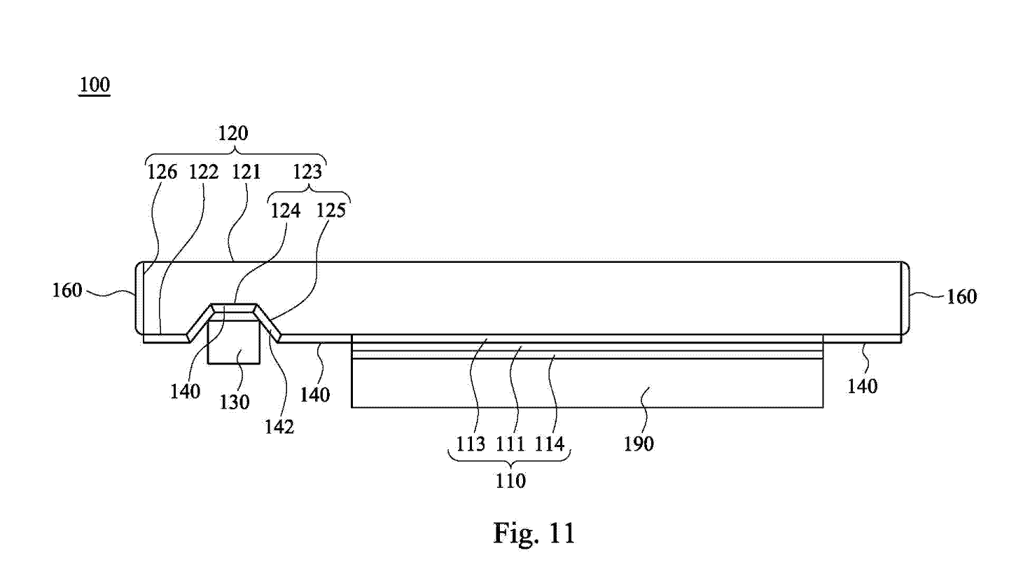

FIG. 11 is a cross-sectional view of a touch device 100 taken along line 2 shown in FIG. 1 according to some embodiments of the instant disclosure. The touch device 100 of the present embodiment is substantially the same as the touch device 100 of FIG. 4, and the major differences will be described hereafter. In the present embodiment, a touch sensing structure 110 includes substrate 111, an upper touch sensing layer 113 and a lower touch sensing layer 114. The upper touch sensing layer 113 and the lower touch sensing layer 114 are respectively disposed on two opposite sides of the substrate 111, and the upper touch sensing layer 113 is located between the cover lens 120 and the substrate 111.

In a related manufacturing process, the upper touch sensing layer 113 and the lower touch sensing layer 114 are first respectively formed on the opposite sides of the substrate 111. Subsequently, the upper touch sensing layer 113 is bonded to the second surface 122, and a display module 190 is bonded to the lower touch sensing layer 114.

In some embodiments, the electrodes of the upper touch sensing layer 113 and lower touch sensing layer 114 are alternately disposed. For instance, the electrode of the upper touch sensing layer 113 is disposed in a vertical direction, and the electrode of the lower touch sensing layer 114 is in a horizontal direction. The electrode of the upper touch sensing layer 113 may be a routing at the driving end, and the electrode of the lower touch sensing layer 114 may be a routing at the receiving end. Alternatively, the electrode of the upper touch sensing layer 113 may be a routing at the receiving end, and the electrode of the lower touch sensing layer 114 may be a routing at the driving end.

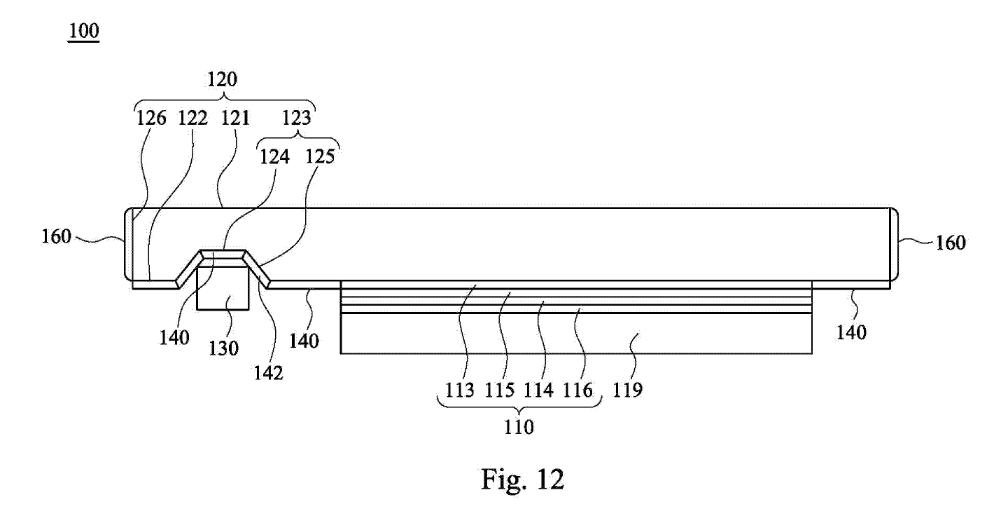

FIG. 12 is a cross-sectional view of a touch device 100 taken along line 2 shown in FIG. 1 according to yet another embodiment of the instant disclosure. The touch device 100 of the present embodiment is substantially the same as the touch device 100 of FIG. 11, and the major differences will be described hereafter. In the present embodiment, a touch sensing structure 110 includes an upper touch sensing layer 113, a lower touch sensing layer 114, an upper substrate 115 and a lower substrate 116. The lower touch sensing layer 114 is disposed on the lower substrate 116, the upper touch sensing layer 113 is disposed on the upper substrate 115, the upper substrate 115 is located between the upper touch sensing layer 113 and the lower touch sensing layer 114, and the upper touch sensing layer 113 is located between the cover lens 120 and the upper substrate 115.

In a related manufacturing process, the upper touch sensing layer 113 and the lower touch sensing layer 114 are first respectively formed on a side of the upper substrate 115 and the lower substrate 116. The upper touch sensing layer 113 is subsequently bonded to a second surface 122, and the lower touch sensing layer 114 is bonded to the upper substrate 115. Further, a display module 190 is bonded to the lower substrate 116.

It should be noted that other embodiments are not limit to the above description. In other embodiments, as long as the upper touch sensing layer 113 and the lower touch sensing layer 114 are insulated from each other, the location of the upper touch sensing layer 113 and the upper substrate 115 may be exchanged, and the location of the lower touch sensing layer 114 and the lower substrate 116 may also be exchanged.

As discussed above with reference to FIG. 9 through 12, the substrate 111, the upper substrate 115 and the lower substrate 116 are made of transparent insulated materials such as glass or plastic film. The plastic film includes polyimide (PI), polypropylene (PP), polystyrene (PS), acrylonitrile—butadiene—styrene (ABS), polyethylene terephthalate (PET), polyvinyl chloride (PVC), polycarbonate (PC), polyethylene (PE), polymethyl methacrylate (PMMA), polytetrafluoroethylene (PTFE) or the like. The touch sensing layer 112, the upper touch sensing layer 113 and the lower touch sensing layer 114 are made of highly transparent conductive materials such as metal nano-wires, transparent metal oxide thin film, metal mesh or the like.

In addition, in some embodiments of the instant disclosure, the touch device 100 further includes a metal ring (not shown) disposed in the groove 123 and surrounding the fingerprint identification structure 130. The metal ring may be used for detecting the touch object, starting the fingerprint structure 130 and improving the signal-to-noise ratio.

The signal-to-noise ratio may be defined as the ratio of the power of a signal (meaningful information) and the power of background noise (unwanted signal). Embodiments of this disclosure are not limited thereto. The person having ordinary skill in the art can make proper modifications to the definition of the signal-to-noise ratio depending on the actual application.

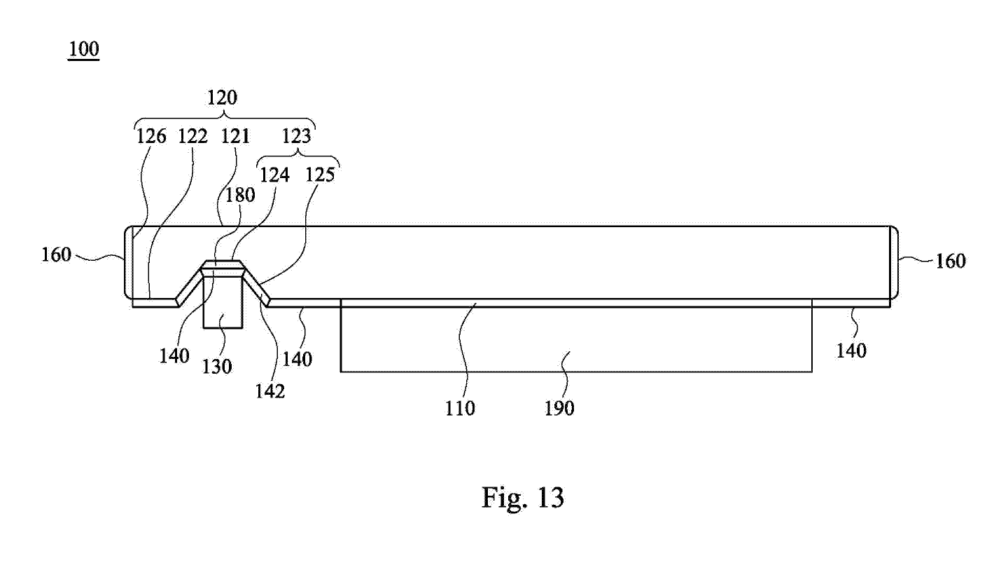

FIG. 13 is a cross-sectional view of a touch device 100 taken along line 2 shown in FIG. 1 according to some embodiments of the instant disclosure. The present embodiment is substantially the same as the embodiment of FIG. 3, and the major differences will be described hereafter.

A cover lens 120 of the present embodiment is made of, for example, glass. A groove 123 disposed on a second surface 122 of the cover lens 120 is mainly formed by using a cutting tool to perform multiple processing, so that many minor marks and cracks occur. In the prior art, wool felt is typically used for performing secondary polishing to repair the marks and the cracks on the glass. However, the corners and edges of the groove cannot be polished by wool felt, and using the wool felt is likely to polish the flat top surface 124 of the groove 123 into an arc, which changes the external appearance of the groove 123. In the present disclosure, a first optical repair layer 180 is further disposed between the top surface 124 of the groove 123 and a first mask layer 140. The main functions of the first optical repair layer 180 are repairing the marks and minor cracks of the groove 123, which is caused by the surface treatment process, reducing fogging and modifying marks. Consequently, the surface of the groove becomes transparent and flat, the optical performance is recovered, and the appearance is improved.

Specifically, the material of the first optical repair layer 180 is a transparent organic gel, a transparent ink or a semi-transparent ink. Due to color contrast between the marks and the cracks of the groove 123 and the first mask layer 140, the marks and the cracks are more obvious. Therefore, the first optical repair layer 180 of the present embodiment is made of transparent organic gel, transparent ink or semi-transparent ink, so that the first optical repair layer 180 can repair the gaps of the marks and the cracks and further improve visual appearance. When the first optical repair layer 180 is made of transparent organic gel, the transparent organic gel has a certain viscosity, and hence the adhesion of the first mask layer 140 to the cover lens 120, which is made of glass, can be improved.

The materials of the organic gel are selected from methyltrichlorosilane, dimethyldichlorosilane, phenyltrichlorosilane, diphenyldichlorosilane, methylphenyldichlorosilane, acrylate, silicone, epoxy resin, urethane resin or a combination thereof.

A method of manufacturing the first optical repair layer 180 of the present embodiment is spraying or pad printing. In the pad printing case, the optical repair material, which is viscous liquid having a certain degree of fluidity, is first printed on the top surface 124 of the groove 123. The optical repair material can penetrate the gaps of the marks and the cracks of the top surface 124 because of its material and fluidity, and the top surface 124 is restored to the original optical performance after filling the gaps. Drying or baking step is performed after pad printing to form the first optical repair layer 180.

The thickness of the first optical repair layer 180 of the present embodiment is in a range from 1 μm to 100 μm. In some embodiments, the range is from 30 μm to 70 μm. As a result, the first optical repair layer 180 can guarantee a sufficient amount to fill the gaps of the marks and the cracks, but also ensure that the top surface 124 of the groove 123 remains flat, and also maintain the effective operation of the fingerprint identification within this thickness range.

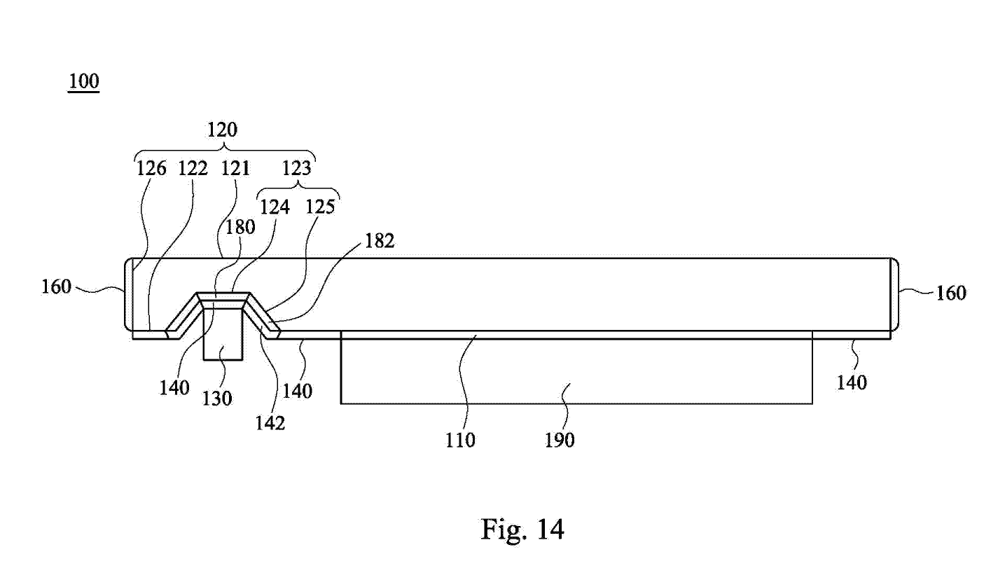

FIG. 14 is a cross-sectional view of a touch device 100 taken along line 2 shown in FIG. 1 according to some embodiment of the instant disclosure. The present embodiment is substantially the same as the embodiment of FIG. 13, and the major differences will be described hereafter. In the present embodiment, the touch device 100 has a second optical repair layer 182 disposed between a side surface 125 of a groove 123 and a second mask layer 142.

The second optical repair layer 182 of the present embodiment can repair marks and cracks, which are generated due to processing, on the side surface 125 of the groove 123 as discussed above, and simultaneously provide better adhesion of the second mask layer 142 formed on the side surface 125. The material, the process and the thickness of the second optical repair layer 182 are described with reference to the illustration of FIG. 13, and hence not repeated herein.

Additional information will be described hereafter. In the actual design, the optical properties of the materials of the first optical repair layer 180 and the second optical repair layer 182 have to match the actually designed color of the first mask layer 140 and the second mask layer 142 of touch device 100 as the main consideration, in order to comply with desired color contrast between the first mask layer 140 and the second mask layer 142 according to the embodiments of FIGS. 13 and 14.

In various embodiments of the instant disclosure, Since the first mask layer and the second mask layer, which have different color, respectively cover the top surface and the side surface of the groove, the first mask layer and the second mask layer have more uniform shielding for opaque elements such as the fingerprint identification structure under the first mask layer and the second mask layer, and simultaneously prevent the light leaking from the groove, especially from the side surface of the groove. Since the color of the first mask layer and the second mask layer are different, the color difference between the first mask layer and the second mask layer may be fully used to enhance their color contrast, in order to improve the poor visual appearance of the touch device caused by the situation that the shielding cannot be uniform due to the different reflection angles of light on the side surface and top surface of the groove of the same color mask layer. In addition, the color of the second mask layer and the first mask layer are different, so that the second mask layer is formed as the fingerprint labeled area to specifically indicate the location of the fingerprint identification area, and further enhance the convenience of use of the touch device.

The above descriptions are only the preferred embodiments of the instant disclosure, but not intended to limit the instant disclosure. Any modification, equivalent substitution, improvement and so on within the spirit and principles of the instant disclosure should be included the scope of protection of the instant disclosure.

What is claimed is:

1. A touch device, comprising:
a cover lens having a first surface and a second surface opposite to the first surface, and the first surface is a touch surface;
a groove disposed on the second surface, and having a top surface and a side surface adjacent to the top surface;
a first mask layer covering the top surface of the groove;
a second mask layer covering the side surface of the groove, wherein the color of the first mask layer and the color of the second mask layer are different;
a fingerprint identification structure, wherein at least a portion of the fingerprint identification structure is disposed on the top surface in the groove; and
a touch sensing structure disposed on the second surface.

2. The touch device of claim 1, wherein the orthographic projection of the first mask layer on the first surface is a fingerprint identification area, the orthographic projection of the second mask layer on the first surface is a fingerprint labeled area, and the fingerprint identification area is surrounded by the fingerprint labeled area.

3. The touch device of claim 2, wherein the first mask layer further covers a peripheral area of the second surface to form a frame area, and the fingerprint identification area and the fingerprint labeled area are in the frame area.

4. The touch device of claim 1, wherein the second mask layer is formed on the side surface by pad printing or ink jet printing.

5. The touch device of claim 1, wherein a color of the first mask layer and the second mask layer are black, white, red, gold or blue respectively.

6. The touch device of claims 1, wherein an angle between the top surface and the side surface is in a range from 110 degrees to 165 degrees.

7. The touch device of claim 1, wherein a surface of the fingerprint identification structure close to the top surface of the groove is a top surface of the fingerprint identification structure, and a minimum distance between the top surface of the fingerprint identification structure and the first surface of the cover lens is in a range from 80 μm to 400 μm.

9. The touch device of claim 1, further comprising a first fixed layer disposed between the fingerprint identification structure and the first mask layer.

10. The touch device of claim 9, further comprising a second fixed layer disposed between the fingerprint identification structure and the second mask layer.

11. The touch device of claim 10, wherein the second fixed layer and the first fixed layer fill the groove.

12. The touch device of claim 10, wherein the second fixed layer encompasses the fingerprint identification structure.

13. The touch device of claim 1, wherein the fingerprint identification structure is in direct contact with the first mask layer.

14. The touch device of claim 13, further comprising a second fixed layer disposed between the fingerprint identification structure and the second mask layer.

15. The touch device of claim 1, wherein the fingerprint identification structure is a sensing electrode structure disposed in the groove and on a portion of the second surface.

16. The touch device of claim 1, wherein the fingerprint identification structure is an integrated circuit chip.

17. The touch device of claim 1, wherein the touch sensing structure is a touch sensing electrode structure formed on the cover lens.

18. The touch device of claim 1, wherein the touch sensing structure comprises a substrate and a touch sensing layer disposed on a side of the substrate.

19. The touch device of claim 1, wherein the cover lens further has a side surface connecting the first surface and the second surface, and the touch device further comprises a buffer layer disposed on the side surface which connects the first surface and the second surface.

20. The touch device of claim 1, further comprising a first optical repair layer disposed between the top surface and the first mask layer.

21. The touch device of claim 20, further comprising a second optical repair layer disposed between the side surface and the second mask layer.

22. The touch device of claim 20, wherein a thickness of the first optical repair layer is in a range from 1 μm to 100 μm.

23. The touch device of claim 20, wherein a material of the first optical repair layer is a transparent organic gel, a transparent ink or a semi-transparent ink.

24. The touch device of claim 21, wherein a thickness and a material of the second optical repair layer and the first optical repair layer are the same.
